(19) United States
(12) Patent Application Publication
(10) Pub. No.: US 2026/0204968 A1
(43) Pub. Date: Jul. 16, 2026

(54) STEPPING MOTOR AND ELECTRIC MOTOR MODULE

(71) Applicant: AAC Microtech (Changzhou) Co., Ltd., Changzhou City (CN)

(72) Inventors: Feng Yan, Changzhou (CN); Jing Fan, Changzhou (CN); Junxiang Han, Changzhou (CN); Junsheng Wang, Changzhou (CN)

(21) Appl. No.: 19/291,591

(22) Filed: Aug. 5, 2025

Related U.S. Application Data
(63) Continuation of application No. PCT/CN2025/072806, filed on Jan. 16, 2025.

(51) Int. Cl. H02K 3/18; H02K 3/52; H02K 5/22; H02K 7/116; H02K 37/14

(52) U.S. Cl. CPC H02K 3/18; H02K 3/525; H02K 5/225; H02K 7/116; H02K 37/14

(57) ABSTRACT

A stepping motor and an electric motor module are provided. The stepping motor including: a housing; a rotating shaft rotatably connected to the housing; a magnetic steel fixed to the rotating shaft; and a winding assembly received and fixed to an inner side surface of the housing and spaced apart from and surrounding an outer side of the magnetic steel. The winding assembly includes an annular bobbin coaxial with the housing; two claw poles spaced apart from each other along an axial direction of the rotating shaft; and a coil wound around an outer peripheral side of the bobbin. The stepping motor in the present invention can not only solve the problem of local wall thickness reduction of the frame causing difficulty in its forming, but also can be further reduced in thickness by coordinating with the corresponding design of other structures.

### CROSS-REFERENCE TO RELATED APPLICATIONS

This application is a continuation of International Application No. PCT/CN2025/072806, filed on January 16, 2025, the entire content of which is incorporated herein by reference.

### TECHNICAL FIELD

The present disclosure relates to the technical field of electric motors, in particular to a stepping motor and an electric motor module.

### BACKGROUND

Stepping motors have been widely applied in fields, such as electric motors, generators, and smart devices, due to their compact structure, high efficiency, and energy-saving advantages.

In conventional technologies, a stepping motor primarily includes a housing, a rotating shaft rotatably connected to the housing, magnetic steel fixed to the outer peripheral side of the rotating shaft, and a winding assembly sleeved on the rotating shaft and rotatably connected to the rotating shaft. The winding assembly is spaced apart from and surrounds the outer side of the magnetic steel. The winding assembly includes a plastic bobbin fixed to the inner side of the housing, two claw poles spaced apart from each other along the axial direction of the rotating shaft, and a coil wound around the outer peripheral side of the plastic bobbin.

The trend toward thinner, lighter, and higher-performance smart devices demands stepping motors to deliver higher torque while occupying smaller thickness and volume. However, in conventional technologies, the plastic bobbin of the stepping motor is often constrained by uniform molding wall thickness requirements, where the bobbin's wall thickness must remain consistent. This prevents further reduction in the motor's thickness dimensions. Therefore, it is necessary to provide a stepping motor and an electric motor module with reduced thickness and improved performance to address this technical issue.

### SUMMARY

The present disclosure aims to provide a novel stepping motor and an electric motor module to solve the problem in conventional technologies where the bobbin of the stepping motor is limited by molding wall thickness constraints, making it impossible to further reduce the motor's thickness dimensions.

In the first aspect, the present invention provides a stepping motor including: a housing; a rotating shaft rotatably connected to the housing; a magnetic steel fixed to the rotating shaft; and a winding assembly received and fixed to an inner side surface of the housing and spaced apart from and surrounding an outer side of the magnetic steel. The winding assembly includes an annular bobbin coaxial with the housing; two claw poles spaced apart from each other along an axial direction of the rotating shaft; and a coil wound around an outer peripheral side of the bobbin. The two claw poles extend into the bobbin and are spaced apart from and opposite to the magnetic steel. The bobbin includes a side wall around which the coil is wound, the side wall including: an arcuate portion having a first thickness; and a first planar portion having a second thickness less than the first thickness. The first planar portion includes an outer surface in contact with the coil, the outer surface being planar.

Preferably, the coil includes: a first coil segment attached to the arcuate portion; and a second coil segment attached to the first planar portion, the first coil segment is arcuate and the second coil segment is a flat plate.

Preferably, the bobbin further includes: an open area penetrating through the first planar portion, a thickness of the first planar portion gradually decreases from two ends connected to the arcuate portion toward the open area.

Preferably, the housing includes a second planar portion disposed opposite and parallel to the first planar portion; each claw pole includes a third planar portion disposed parallel to and matching with the second planar portion; both the second planar portion and the third planar portion are flat plates.

Preferably, the bobbin further includes: two annular enclosing portions respectively formed by two opposite axial ends of the side wall bending and extending outward; an extension portion protruding from a side of one of the enclosing portions away from the side wall; and two winding posts spaced apart from each other and extending from a side of the extension portion away from the enclosing portion; the housing is provided with a through hole penetrating therethrough; the extension portion extends from the through hole to an outer side of the housing; each enclosing portion includes a fourth planar portion parallel to and matching with the second planar portion, and the fourth planar portion is a flat plate; the first planar portion is parallel to an extending direction of the winding posts; and each of two ends of the coil is wound around one of the two winding posts.

Preferably, each claw pole includes: an annular fixing portion fixed to the housing; and a plurality of claw teeth bent and extending from an inner periphery of the fixing portion along an axial direction of the rotating shaft; the claw teeth are spaced apart from each other, extend into the bobbin, and are fixedly connected to the bobbin; the third planar portion is disposed on the fixing portion; and the claw teeth of one claw pole are positioned between two adjacent claw teeth of the other claw pole.

Preferably, the housing includes: two cover plates fixed to two ends of the rotating shaft via rotary bearings; and an annular body portion fixedly connected to the two cover plates; the second planar portion is disposed on the body portion; each cover plate includes a fifth planar portion parallel to and matching with the second planar portion; and the fifth planar portion is a flat plate.

Preferably, the stepping motor includes at least two winding assemblies, and the at least two winding assemblies are stacked in sequence along the axial direction of the rotating shaft.

Preferably, the bobbin includes two first planar portions, and the two first planar portions are disposed opposite to each other along a radial direction of the rotating shaft.

In the second aspect, the present invention provides an electric motor module including: the stepping motor described above; and a gearbox fixed to one end of the rotating shaft and rotatably connected to the rotating shaft. The gearbox includes a sixth planar portion parallel to and matching with the second planar portion, and the sixth planar portion is a flat plate.

Preferably, the gearbox includes: a hollow casing; a connection bearing fixed to one end of the casing; a connection portion fixed within the connection bearing; a gear set received within the casing and in mesh with the connection portion; and a shaft body in mesh with the gear set and extending outside the casing; the sixth planar portion is disposed on a side surface of the casing corresponding to the second planar portion; a preset distance is provided between the gear set and the connection bearing.

Preferably, the casing has a circular cross-section and includes: a first connection segment adjacent to the rotating shaft; and a second connection segment extending from the first connection segment away from the rotating shaft; an outer diameter of the first connection segment is greater than that of the second connection segment; the sixth planar portion is disposed on a side surface of the first connection segment corresponding to the second planar portion; the sixth planar portion is coplanar with an outer side surface of the second connection segment; the connection bearing is fixed to the first connection segment; the gear set is received within the second connection segment; a distance between the gear set and the first connection segment is defined as the preset distance.

Compared to conventional technologies, the stepping motor of the present disclosure reduces injection molding pressure for the bobbin by designing the side wall to include an arcuate portion with a first thickness and a first planar portion with a second thickness that is less than the first thickness, where the first planar portion has a planar outer surface contacting the coil. This design effectively reduces molding pressure while overcoming formation difficulties caused by the localized thickness reduction, ensuring successful injection molding of the bobbin. When combined with corresponding designs of other components, this configuration enables either significant reduction in the stepping motor 100's thickness while maintaining equivalent torque output, or 15-25% torque improvement while maintaining equivalent thickness dimensions.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a perspective view of a stepping motor according to Embodiment 1 of the present disclosure;

FIG. 2 is an exploded partial view of the stepping motor according to Embodiment 1 of the present disclosure;

FIG. 3 is a cross-sectional view taken along line A-A in FIG. 1;

FIG. 4 is a cross-sectional view taken along line B-B in FIG. 1;

FIG. 5 is a perspective view of an electric motor module according to Embodiment 2 of the present disclosure; and

FIG. 6 is an exploded partial view of the electric motor module according to Embodiment 2 of the present disclosure.

Reference numerals in the drawings denote as follows: 100, stepping motor; 1, rotating shaft; 2, magnetic steel; 3, winding assembly; 31, bobbin; 311, side wall; 3111, arcuate portion; 3112, first planar portion; 31121, open area; 312, enclosing portion; 3121, fourth planar portion; 313, extension portion; 314, winding post; 32, claw pole; 321, fixing portion; 3211, third planar portion; 322, claw teeth; 33, coil; 331, first coil segment; 332, second coil segment; 4, housing; 41, cover plate; 411, fifth planar portion; 42, rotary bearing; 43, body portion; 431, second planar portion; 44, through hole.

200, electric motor module; 5, gearbox; 51, casing; 511, first connection segment; 5111, sixth planar portion; 512, second connection segment; 52, connection bearing; 53, connection portion; 54, gear set; 55, shaft body.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments in the present disclosure, all other embodiments obtained by those ordinarily skilled in the art without doing creative work shall fall within the protection scope of the present disclosure.

### Embodiment 1

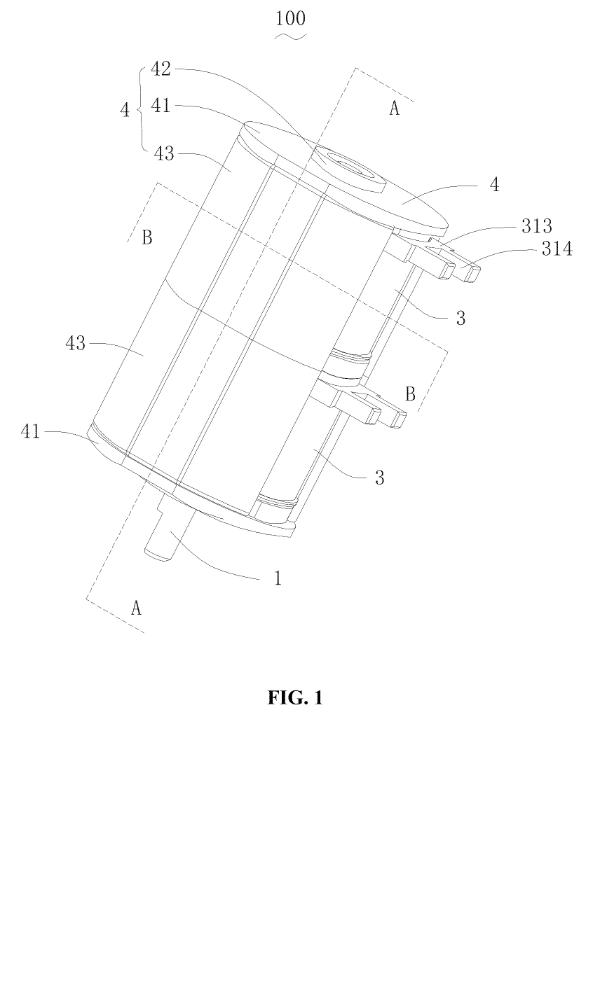

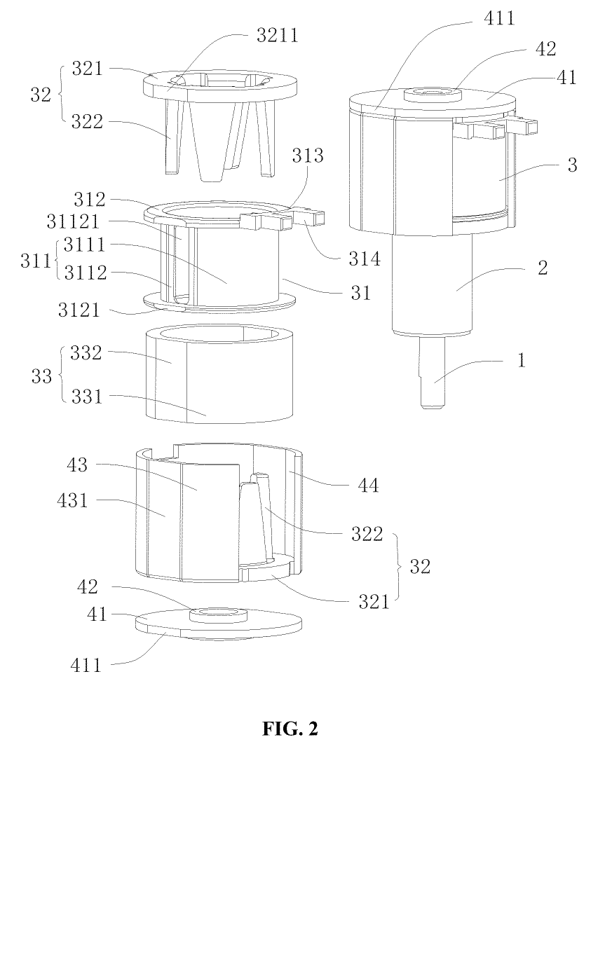

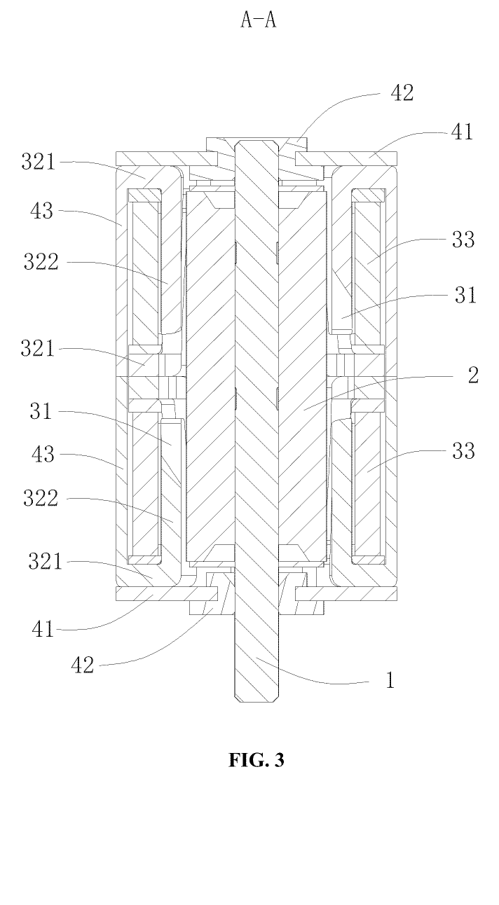

The embodiment of the present disclosure provides a stepping motor 100. As shown in FIGS. 1 to 3, the stepping motor includes a housing 4, a rotating shaft 1 rotatably connected to the housing 4, a magnetic steel 2 fixed to the rotating shaft 1, and a winding assembly 3 received and fixed to an inner side surface of the housing 4. The winding assembly 3 is spaced apart from and surrounds an outer side of the magnetic steel 2.

The winding assembly 3 includes an annular bobbin 31 coaxial with the housing 4, two claw poles 32 spaced apart from each other along an axial direction of the rotating shaft 1, and a coil 33 wound around an outer peripheral side of the bobbin 31. The two claw poles 32 extend into the bobbin 31 and are spaced apart from and opposite to the magnetic steel 2.

The bobbin 31 includes a side wall 311 around which the coil 33 is wound. The side wall 311 includes an arcuate portion 3111 having a first thickness and a first planar portion 3112 having a second thickness less than the first thickness. The first planar portion 3112 includes an outer surface in contact with the coil 33, and the outer surface is planar.

The coil 33 includes a first coil segment 331 attached to the arcuate portion 3111 and a second coil segment 332 attached to the first planar portion 3112. The first coil segment 331 is arcuate and the second coil segment 332 is a flat plate. By configuring the second coil segment 332 attached to the first planar portion 3112 as a flat plate, the thickness dimension of the stepping motor 100 can be further reduced in cooperation with the corresponding designs of other structures.

The bobbin 31 further includes an open area 31121 penetrating through the first planar portion 3112. A thickness of the first planar portion 3112 gradually decreases from two ends connected to the arcuate portion 3111 toward the open area 31121. Preferably, the open area 31121 is disposed at a central position of the first planar portion 3112, wherein a plastic material at a thinnest central region of the first planar portion 3112 is removed. This configuration prevents the bobbin 31 from having extremely thin wall sections or allows incomplete filling during molding to create similar voids, thereby ensuring the moldability of the bobbin 31.

The bobbin 31 is designed with an optimal wall thickness throughout all structural regions except the first planar portion 3112, with the arcuate portion 3111 specifically designed with the optimal wall thickness. This design approach implements the optimal wall thickness configuration for the entire bobbin 31, achieving a minimal manufacturable thickness that ensures both molding feasibility and structural integrity while maintaining the compactness of the bobbin 31.

The housing 4 includes a second planar portion 431 disposed opposite and parallel to the first planar portion 3112, and the second planar portion 431 is a flat plate. This configuration cooperates with corresponding designs of other structures to further reduce the thickness dimension of the stepping motor 100.

The housing 4 includes two cover plates 41 fixed to two ends of the rotating shaft 1 via rotary bearings 42, and an annular body portion 43 fixedly connected to the two cover plates 41. The second planar portion 431 is disposed on the body portion 43. This configuration enables rotational connection between the housing 4 and the rotating shaft 1.

The cover plate 41 includes a fifth planar portion 411 parallel to and matching with the second planar portion 431, and the fifth planar portion 411 is a flat plate. This configuration cooperates with corresponding designs of other structures to further reduce the thickness dimension of the stepping motor 100.

The bobbin 31 further includes: two annular enclosing portions 312 respectively formed by outward bending and extending of two opposite axial ends of the side wall 311 along the rotating shaft 1; an extension portion 313 protruding from a side of one of the enclosing portions 312 away from the side wall 311; and two winding posts 314 spaced apart from each other and protruding and extending from a side of the extension portion 313 away from the enclosing portion 312. The housing 4 is provided with a through hole 44 penetrating therethrough. The extension portion 313 extends from the through hole 44 to an outer side of the housing 4. Each enclosing portion 312 includes a fourth planar portion 3121 parallel to and matching with the second planar portion 431, and the fourth planar portion 3121 is a flat plate. The first planar portion 3112 is parallel to an extending direction of the winding posts 314. Two ends of the coil 33 are respectively wound around the two winding posts 314. The configuration of the winding posts 314 facilitates winding of the two ends of the coil 33, while the arrangement of the fourth planar portions 3121 on the enclosing portions 312 cooperates with corresponding structures to further reduce the thickness dimension of the stepping motor 100.

The claw pole 32 includes a third planar portion 3211 parallel to and matching with the second planar portion 431, and the third planar portion 3211 is a flat plate. The housing 4 is designed with a predetermined safety clearance relative to the coil 33. This configuration allows the claw pole 32 to adapt to both the first planar portion 3112 and the second coil segment 332 of the coil 33, enabling a minimum-space arrangement with uniform gaps in the stepping motor 100, thereby the structural compactness of the stepping motor 100 is ensured and the overall thickness dimension is further reduced.

The claw pole 32 includes: an annular fixing portion 321 fixed to the housing 4; and a plurality of claw teeth 322 bent and extending from an inner periphery of the fixing portion 321 along an axial direction of the rotating shaft 1. The claw teeth 322 are spaced apart from each other, extend into the bobbin 31, and are fixedly connected to the enclosing portions 312 of the bobbin 31. The third planar portion 3211 is disposed on the fixing portion 321. The claw teeth 322 of one claw pole 32 are positioned between two adjacent claw teeth 322 of the other claw pole 32.

The bobbin 31 includes two first planar portions 3112 disposed opposite to each other along a radial direction of the rotating shaft 1. Correspondingly, each of the second planar portion 431, the third planar portion 3211, the fourth planar portion 3121, and the fifth planar portion 411 includes two portions arranged oppositely along the radial direction of the rotating shaft 1. The first planar portions 3112, the second planar portions 431, the third planar portions 3211, the fourth planar portions 3121, and the fifth planar portions 411 on the same side are coplanar.

The stepping motor may be provided with either a single winding assembly 3 or a plurality of winding assemblies 3. In configurations where the plurality of winding assemblies 3 are provided, the winding assemblies 3 are sequentially stacked along the axial direction of the rotating shaft 1.

When the winding assembly 3 and the body portion 43 are each provided as one, the two ends of the body portion 43 are respectively fixedly connected to the two cover plates 41. Correspondingly, the rotating shaft 1 is rotatably connected to the housing 4 via the cover plates 41 and the rotary bearings 42. Meanwhile, the two claw poles 32 of the winding assembly 3 are respectively fixed to the two ends of the body portion 43.

When a plurality of winding assemblies 3 are provided, the quantity of body portions 43 corresponds to the number of winding assemblies 3. The plurality of body portions 43 are sequentially and fixedly interconnected. The opposing ends of the outermost two body portions 43 are respectively fixedly connected to the two cover plates 41, thereby forming a rotational connection between the rotating shaft 1 and the housing 4 via the cover plates 41 and the rotary bearings 42. Concurrently, the two claw poles 32 of each winding assembly 3 are respectively fixed to opposite ends of a corresponding body portion 43. Additionally, for each winding assembly 3, the first planar portion 3112, the second planar portion 431, the third planar portion 3211, the fourth planar portion 3121, and the fifth planar portion 411 are coplanar. Where each of the planar portions includes two portions, the first planar portion 3112, the second planar portion 431, the third planar portion 3211, the fourth planar portion 3121, and the fifth planar portion 411 on the same side are coplanar.

In this embodiment, the winding assembly 3 includes two units sequentially arranged along the axial direction of the rotating shaft 1, and correspondingly, the housing 4 includes two body portions 43.

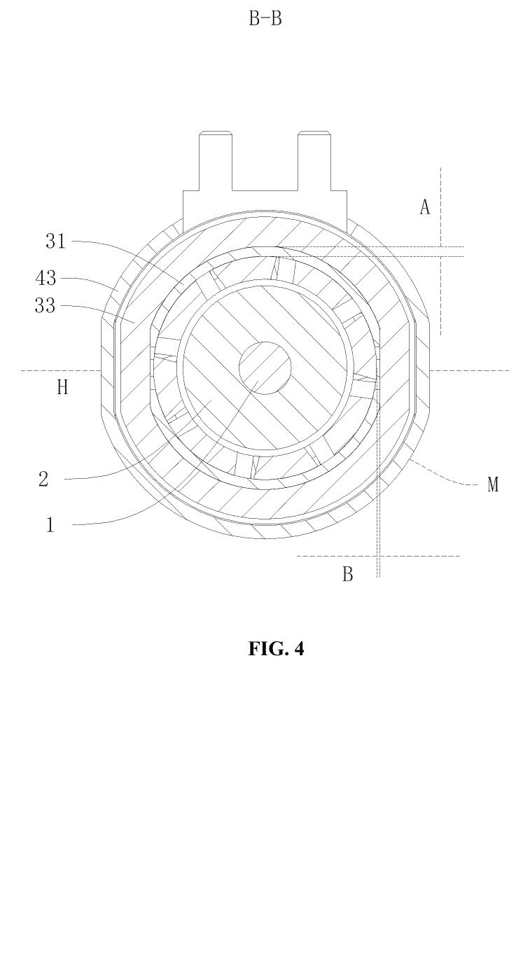

As shown in FIG. 4, with the central wall thickness of the first planar portion 3112 of the bobbin 31 defined as B and the wall thickness of remaining portions of the bobbin 31 (excluding the first planar portion 3112) defined as A, the overall thickness dimension H of the stepping motor 100 is reduced by 2×(A−B). Given A=0.15 mm and B=0.05 mm, for a conventional stepping motor having an original width (or outer diameter dimension) of 5.2 mm and an original length (including the extension portion and winding portion) of 8 mm, the implementation of the stepping motor 100 according to this embodiment reduces the overall thickness dimension by 2×(0.15−0.05)=0.2 mm, with a corresponding torque increase of 15% to 25%. Where the outer diameter dimension of the stepping motor 100 is defined as M, then M=H+2×(A−B). This embodiment also covers implementations where M≥H+2×(A−B).

Compared to conventional technologies, the stepping motor 100 of the present disclosure reduces injection molding pressure for the bobbin 31 by designing the side wall 311 to include an arcuate portion 3111 with a first thickness and a first planar portion 3112 with a second thickness that is less than the first thickness, where the first planar portion 3112 has a planar outer surface contacting the coil 33. This design effectively reduces molding pressure while overcoming formation difficulties caused by the localized thickness reduction, ensuring successful injection molding of the bobbin 31. When combined with corresponding designs of other components, this configuration enables either significant reduction in the stepping motor 100's thickness while maintaining equivalent torque output, or 15-25% torque improvement while maintaining equivalent thickness dimensions.

### Embodiment 2

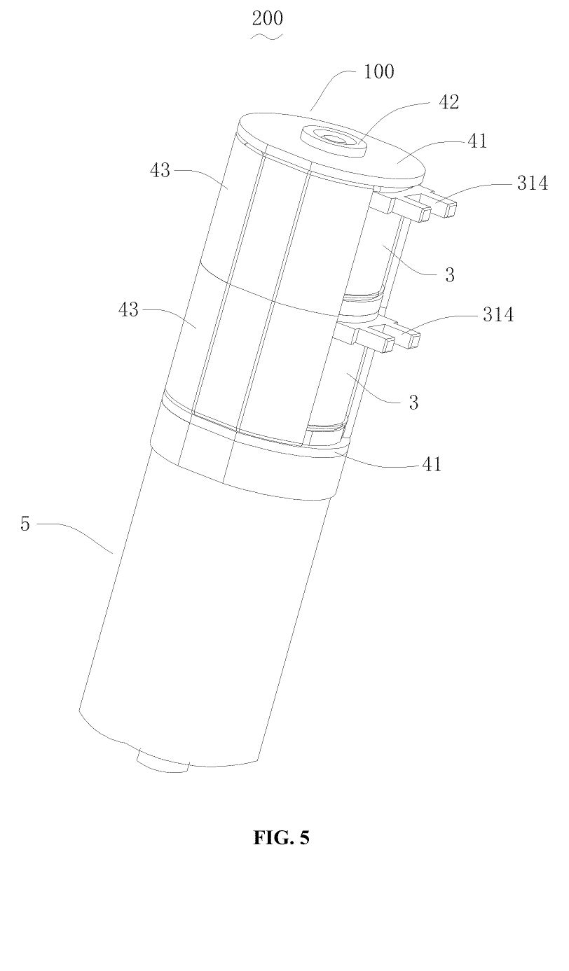

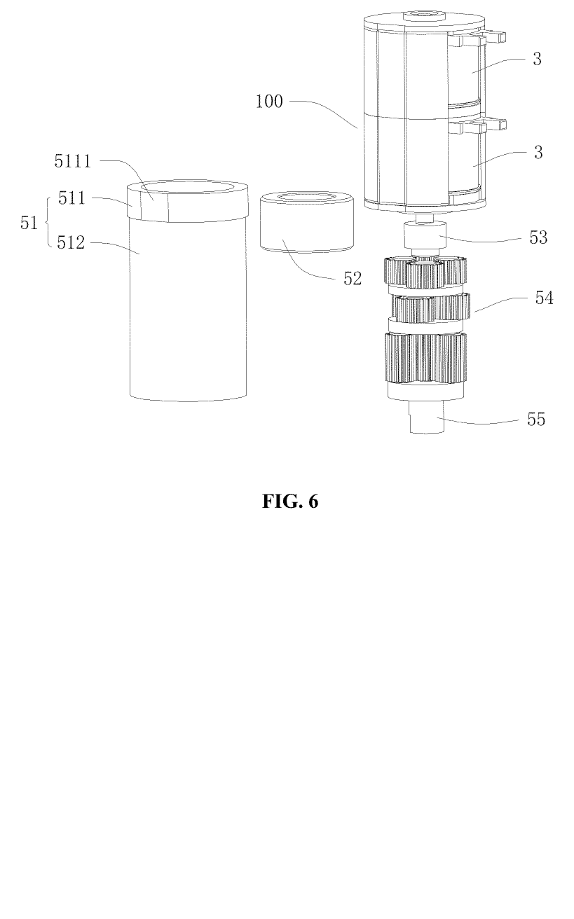

The embodiment of the present disclosure provides an electric motor module 200. As shown in FIGS. 5 and 6, the electric motor module 200 includes the stepping motor 100 described in Embodiment 1 and a gearbox 5 fixed to one end of the rotating shaft 1 and rotatably connected to the rotating shaft 1. The gearbox 5 includes a sixth planar portion 5111 parallel to and matching with the second planar portion 431, and the sixth planar portion 5111 is a flat plate. By incorporating the gearbox 5 and designing the sixth planar portion 5111, the structure of the gearbox 5 can be matched with the first planar portion 3112, the second planar portion 431, the third planar portion 3211, the fourth planar portion 3121, and the fifth planar portion 411. This enables the stepping motor 100 to achieve higher torque gain while maintaining the same width dimensions.

The gearbox 5 includes a hollow casing 51, a connection bearing 52 fixed to one end of the casing 51, a connection portion 53 fixed within the connection bearing 52, a gear set 54 received within the casing 51 and in mesh with the connection portion 53, and a shaft body 55 in mesh with the gear set 54 and extending outside the casing 51. The sixth planar portion 5111 is disposed on a side surface of the casing 51 corresponding to the second planar portion 431, with a preset distance (safety distance) maintained between the gear set 54 and the connection bearing 52. This configuration enables optimal matching between the gearbox 5 and the first planar portion 3112, the second planar portion 431, the third planar portion 3211, the fourth planar portion 3121, and the fifth planar portion 411, while ensuring component manufacturability and production process reliability.

The casing 51 has a circular cross-section and includes a first connection segment 511 adjacent to the rotating shaft 1 and a second connection segment 512 extending from the first connection segment 511 away from the rotating shaft 1. The outer diameter of the first connection segment 511 is greater than that of the second connection segment 512. The sixth planar portion 5111 is disposed on a side surface of the first connection segment 511 corresponding to the second planar portion 431, and is coplanar with an outer side surface of the second connection segment 512. The connection bearing is fixed to the first connection segment 511, while the gear set 54 is received within the second connection segment 512. The distance between the gear set 54 and the first connection segment 511 is defined as the preset distance. This design ensures that the length of the sixth planar portion 5111 meets welding alignment requirements while maintaining a safety distance for the gear set 54 position, thereby guaranteeing optimal roundness of the second connection segment 512. Additionally, the spacing between two sixth planar portions 5111 equals the outer diameter of the second connection segment 512, which maintains the minimal thickness of the gearbox 5.

When the second planar portion 431 includes two, the sixth planar portion 5111 also includes two. The spacing between the two sixth planar portions 5111 is equal to the outer diameter of the second connection segment 512, and the first planar portion 3112, the second planar portion 431, the third planar portion 3211, the fourth planar portion 3121, the fifth planar portion 411, and the sixth planar portion 5111 on the same side are all coplanar.

Since the electric motor module 200 in this embodiment incorporates the stepping motor 100 from Embodiment 1, the electric motor module 200 of the present embodiment consequently achieves all the technical effects attained by the stepping motor 100 described in Embodiment 1, which will not be redundantly described herein.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

What is claimed is:

1. A stepping motor comprising:
a housing;
a rotating shaft rotatably connected to the housing:
a magnetic steel fixed to the rotating shaft; and
a winding assembly received and fixed to an inner side surface of the housing and spaced
apart from and surround an outer side of the magnetic steel;
wherein the winding assembly comprises:
an annular bobbin coaxial with the housing;
two claw poles spaced apart from each other along an axial direction of the rotating shaft; and
a coil wound around an outer peripheral side of the bobbin;
wherein the two claw poles extend into the bobbin and are spaced apart from and opposite to the magnetic steel;
wherein the bobbin comprises a side wall around which the coil is wound, the side wall comprising:
an arcuate portion having a first thickness; and
a first planar portion having a second thickness less than the first thickness,
wherein the first planar portion comprises an o9uter surface in contact with the coil, the outer surface being planar.

2. The stepping motor according to claim 1, wherein the coil comprises:
a first coil segment attached to the arcuate portion; and
a second coil segment attached to the first planar portion,
the first coil segment is arcuate and the second coil segment is a flat plane.

3. The stepping motor according to claim 1, wherein the bobbin further comprises:
an open area penetrating through the first planar portion,
a thickness of the first planar portion gradually decreases from two ends connected to the arcuate portion toward the open area.

4. The stepping motor according to claim 1, wherein the housing comprises a second planar portion disposed opposite and parallel to the first planar portion; each claw pole comprises a third planar portion disposed parallel to and matching with the second planar portion; both the second planar portion and the third planar portion are flat plates.

5. The stepping motor according to claim 4, wherein the bobbin further comprises:
two annular enclosing portions respectively former by two opposite axial ends of the side wall bending and extending outward;
an extension portion protruding from a side of one of the enclosing portions away from the side wall; and
two winding posts spaced apart from each other and extending from a side of the extension portion away from the enclosing portion;
the housing is provided with a through hole penetrating therethrough; the extension portion extends from the through hole to an outer side of the housing; each enclosing portion comprises a fourth planar portion parallel to and matching with the second planar portion, and the fourth planar portion is a flat play; the first planar portion is parallel to an extending direction of the winding posts; and each of two ends of the coil is wound around one of the two winding posts.

6. The stepping motor according to claim 4, wherein each claw pole comprises:
an annular fixing portion fixed to the housing; and
a plurality of claw teeth bent and extending from an inner periphery of the fixing portion along an axial direction of the rotating shaft;
the claw teeth are spaced apart from each other, extend into the bobbin and are fixedly connected to the bobbin; the third planar portion is disposed on the fixing portion; and the claw teeth of one claw pole are positioned between two adjacent claw teeth of the other claw pole.

7. The stepping motor according to claim 4, wherein the housing comprises:
two cover plates fixed to two ends of the rotating shaft via rotary bearings; and
an annular body portion fixedly connected to the two cover plates;
the second planar portion is disposed on the body portion; each cover plate comprises a fifth planar portion to and matching with the second planar portion; and the fifth planar portion is a flat plate.

8. The stepping motor according to claim 1, wherein the stepping motor comprises at least two winding assemblies, and the at least two winding assemblies are stack in sequence along the axial direction of the rotating shaft.

9. The stepping motor according to claim 1, wherein the bobbin comprises two first planar portions, and the two first planar portions are disposed opposite to each other along a radial direction of the rotating shaft.

10. An electric motor module comprising:
the stepping motor according to claim 4; and
a gearbox fixed to one end of the rotating shaft and rotatably connected to the rotating shaft
wherein the gearbox comprises a sixth planar portion parallel to and matching with the second planar portion, and the sixth planar portion is a flat plate.

11. The electric motor module according to claim 10, wherein the gearbox comprises:
a hollow casing;
a connection bearing fixed to one end of the casing;
a connection portion fixed within the connection bearing;
a gear set received within the casing and in mesh with the connection portion; and
a shaft body in mesh with the gear set and extending outside the casing;
the sixth planar portion is disposed on a side surface of the casing corresponding to the second planar portion; a preset distance is provided between the gear and the connection bearing.

12. The electric motor module according to claim 11, wherein the casing has a circular cross-section and comprises:
a first connection segment adjacent to the rotating shaft; and
a second connection segment extending from the first connection segment away from the rotating shaft;
an out diameter of the first connection segment is greater than that of the second connection segment; the sixth planar portion is disposed on a side surface of the first connection segment corresponding to the second planar portion; the sixth planar portion is coplanar with an outer side surface of the second connection segment; the connection bearing is fixed to the first connection segment; the gear is received within the second connection segment; a distance between the gear set and the first connection segment is defined as the preset distance.
